(19) United States
(12) Patent Application Publication
(10) Pub. No.: US 2026/0027678 A1
(43) Pub. Date: Jan. 29, 2026

(54) SANITARY CLAMP DEVICE

(71) Applicant: DELTA ELECTRONICS, INC., Taoyuan City (TW)

(72) Inventors: Li-An Chung, Taoyuan City (TW); Cih-Ping Wang, Taoyuan City (TW); Sheng-Chi Wu, Taoyuan City (TW); Yu-Cheng Chang, Taoyuan City (TW); Chung-Ju Tsai, Taoyuan City (TW)

(21) Appl. No.: 19/273,807

(22) Filed: Jul. 18, 2025

Related U.S. Application Data
(60) Provisional application No. 63/676,560, filed on Jul. 29, 2024.

(30) Foreign Application Priority Data
Dec. 6, 2024 (CN) 202411783951.0

(51) Int. Cl. B25B 5/14; B25B 5/04; B25B 5/16; F16L 37/12

(52) U.S. Cl. CPC B25B 5/147; B25B 5/04; B25B 5/16; F16L 37/1205

(57) ABSTRACT

A sanitary clamp device is disclosed and includes two half-ring components, a locking component and a cylindrical handle. The two half-ring components are connected through an adapter component and allowed to rotate around the adapter component so that locked ends of the two half-ring components engage with each other to releasably connect two sanitary fittings therebetween. The locking component is spatially corresponding to the locked ends of the two half-ring components. The locking end of the locking component is connected to the locked ends of the two half-ring components. The operating end is cooperated with a rotating locking component to lock or unlock the two half-ring components through the locking ends. The cylindrical handle runs through the operating end of the locking component. The cylindrical handle allows sliding relative to the operating end to adjust a force-arm length defined from one end of the cylindrical handle to the operating end.

### CROSS-REFERENCE TO RELATED APPLICATION

This application claims the benefit of U.S. Provisional Application No. 63/676,560 filed on Jul. 29, 2024, and entitled “AIR ASSISTED LIQUID COOLING SYSTEM WITH TOOLLESS SANITARY TRI-CLAMP DESIGN, Y-SHAPED TUBE DESIGN AND FAN BLIND INSERTION DESIGN”. This application claims priority to China Patent Application No. 202411783951.0, filed on Dec. 6, 2024. The entireties of the above-mentioned patent applications are incorporated herein by reference for all purposes.

### FIELD OF THE INVENTION

The present disclosure relates to a clamp device, and more particularly to a sanitary clamp device, which is used to releasably connect two sanitary accessories of the water cooling system, and capable of being removed or installed without tools when replacing the clamped sanitary accessories.

### BACKGROUND OF THE INVENTION

In the server room, more and more customers require tool-free for maintenance. However, on the pipelines or pipeline components of the equipment, it is often encountered that tools need to be used for disassembly and assembly at the joints of the pipe accessories.

Furthermore, the general threaded pipe connection method is equipped with anoxic glue or anti-leak tape to stop leakage. This may cause particles and difficulty in controlling directionality. In that, the sanitary pipe accessories are a good choice.

However, even a sanitary coupling, including nut locking and wing handle locking, is used under the design, an extended tool is still required to tighten the screw head to avoid leakage situation. In addition, space limitations are often encountered within the machine, and it may result in tools being unable to reach in.

Therefore, there is a need of providing a sanitary clamp device used to releasably connect two sanitary accessories of the water cooling system, and capable of being removed or installed without tools when replacing the clamped sanitary accessories, so as to obviate the drawbacks encountered by the prior arts.

### SUMMARY OF THE INVENTION

An object of the present disclosure is to provide a sanitary clamp device used to releasably connect two sanitary accessories of the water cooling system, and capable of being removed or installed without tools when replacing the clamped sanitary accessories, so as to effectively simplify the operating procedures and improve the work efficiency.

Another object of the present disclosure is to provide a sanitary clamp device. The two pivoted half-ring components are locked together by a locking component with a cylindrical handle, so that the two sanitary accessories can be releasably connected between the two half-ring components. Since the cylindrical handle is slidingly connected to the locking component, when the user wants to connect two sanitary accessories between the two half-ring components, the installation or disassembly of the sanitary clamp device can be completed by operating the locking component through the cylindrical handle. There is no need to carry other tools such as movable wrenches, spanners, and screwdrivers. The sanitary clamp device or the present disclosure is operated with bare hands. The locking component needs to provide high locking torque to lock the locked ends of the two half-ring components. By sliding the cylindrical handle vertically relative to the locking component, a force-arm length defined from one end of the cylindrical handle to the rotation axis of the locking component is adjustable. It allows the users to easily install or remove the sanitary clamp device. The user can adjust the length of the cylindrical handle relative to the rotation axis of the locking component to increase the locking torque. Furthermore, when the cylindrical handle rotates the locking component to lock or release, the length of the cylindrical handle can be adjusted arbitrarily, and the cylindrical handle can be easily adjusted to a suitable position at any angle for disassembly and assembly. Thereby, the space waste is reduced, and the obstacles of environmental space are overcome. Moreover, the installation or the disassembly of the sanitary clamp device can be successfully completed. On the other hand, the cylindrical handle and locking component have smaller size and operating space than the two half-ring components. Preferably, the size of the two half-ring components is designed relative to the two connected sanitary accessories. The sanitary clamp device can be constructed for any shape and size easily, and the operation is completed with bare hands, so that the use of other tools is eliminated. In the operating space constructed by the cylindrical handle and the locking component, an auxiliary operating section such as a hexagonal nut can also be added for other auxiliary tools to hold and control the locking component. In this way, during production quality control, the sanitary clamp device of the present disclosure further provides the auxiliary operating section for the factory torque wrench to perform the torque control. The sanitary clamp device can be used to connect the accessories of the water cooling system. When replacing the clamped sanitary accessories, tool-free removal or installation is achieved.

In accordance with an aspect of the present disclosure, a sanitary clamp device is provided and includes a first half-ring component, a second half-ring component, a locking component and a cylindrical handle. The first half-ring component includes a first pivoted end and a first locked end opposite to each other. The second half-ring component includes a second pivoted end and a second locked end opposite to each other, wherein the first pivoted end of the first half-ring component and the second pivoted end of the second half-ring component are connected through an adapter component, and the first half-ring component and the second half-ring component are allowed rotating relative to each other around the adapter component as a center, respectively, so that the first locked end and the second locked end are engaged with each other to releasably connect two sanitary accessories between the first half-ring component and the second half-ring component, or the first locked end and the second locked end are detached to release the two sanitary accessories. The locking component is spatially corresponding to the first locked end and the second locked end, wherein the locking component includes a locking end and an operating end opposite to each other, the locking end is connected to the first locked end or the second locked end, and the operating end is configured to rotate the locking end, so that the first locked end and the second locked end are locked or unlocked through the locking end. The cylindrical handle runs through the operating end of the locking component, wherein the cylindrical handle is allowed sliding relative to the operating end to adjust a force-arm length defined from one end of the cylindrical handle to the operating end.

In an embodiment, the first pivoted end of the first half-ring component is pivoted to the adapter component through a first rotation axis, the second pivoted end of the second half-ring component is pivoted to the adapter component through a second rotation axis, and the first rotation axis and the second rotation axis are parallel to each other.

In an embodiment, the first locked end includes a first groove, the second locked end includes a second groove, and the first groove and the second groove are spatially corresponding to each other, wherein the locking component includes a connection column, one end of the connection column is connected to the locking end, the other end of the connection column is pivoted to the first locked end from the first groove through a third rotation axis, the third rotation axis is parallel to the first rotation axis and the second rotation axis, and the connection column is spatially corresponding to the first groove and the second groove, wherein the locking component is allowed rotating around the third rotation axis as a center through the connection column, so that the connection column is received in the second groove or moved away from the second groove.

In an embodiment, the connection column, the locking end and the operating end are arranged along a fourth rotation axis, the fourth rotation axis is perpendicular to the third rotation axis, and when the connection column is received in the second groove, the operating end is allowed rotating the locking component to abut the second locked end through the locking end, so that the first locked end and the second locked end are engaged and locked.

In an embodiment, the cylindrical handle intersects perpendicularly with the fourth rotation axis.

In an embodiment, the cylindrical handle forms an operating distance relative to the third rotation axis, the first half-ring component and the second half-ring component have a peripheral radius, and the operating distance is greater than the peripheral radius and less than twice the peripheral radius.

In an embodiment, the cylindrical handle includes two limiting parts, and the two limiting parts are detachably connected to two opposite ends of the cylindrical handle.

In an embodiment, the cylindrical handle includes a double-headed bolt, and the two limiting parts are two nuts, which are detachably connected to two opposite ends of the double-headed bolt.

In an embodiment, the cylindrical handle forms a sliding section between the two limiting parts, and the sliding section is a cylinder.

In an embodiment, when one of the two limiting parts is in contact with the operating end of the locking component, the other of the two limiting parts forms a maximum force-arm length relative to the operating end.

In an embodiment, the locking component further includes an auxiliary operating section, the auxiliary operating section is connected between the locking end and the operating end and configured for a tool to hold to operate the locking component.

In an embodiment, the auxiliary operating section is a hexagonal cylinder or a hexagonal nut.

In an embodiment, the first half-ring component includes a first engaging groove recessed in an inner peripheral wall of the first half-ring component, the second half-ring component includes a second engaging groove recessed in an inner peripheral wall of the second half-ring component, and the first engaging groove and the second engaging groove are spatially corresponding to each other, wherein when the first locked end and the second locked end are locked with each other, the first engaging groove and the second engaging groove are in communication with each other to form an annular groove, so that the two sanitary accessories are connected between the first half-ring component and the second half-ring component.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a perspective structural view illustrating a sanitary clamp device clamping two sanitary accessories to form a connection according to an embodiment of the present disclosure;

FIG. 2 is a perspective structural view illustrating the sanitary clamp device releasing the two sanitary accessories according to the embodiment of the present disclosure;

FIG. 3 is a perspective structural view illustrating a locking state of the locking component of the sanitary clamp device according to the embodiment of the present disclosure;

FIG. 4 is a perspective structural view illustrating the locking component of the sanitary clamp device releasing the second half-ring component according to the embodiment of the present disclosure;

FIG. 5 is a schematic diagram showing the sanitary clamp device fully unfolded according to the embodiment of the present disclosure; and

FIG. 6 is a schematic diagram showing the dimensional relationship of each component in the sanitary clamp device according to the embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “inner,” “outer” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the “first,” “second” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, “and/or” and the like may be used herein for including any or all combinations of one or more of the associated listed items.

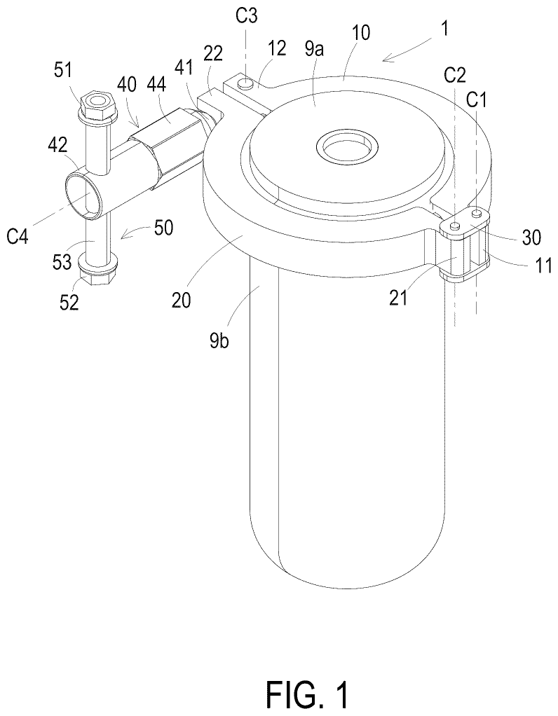

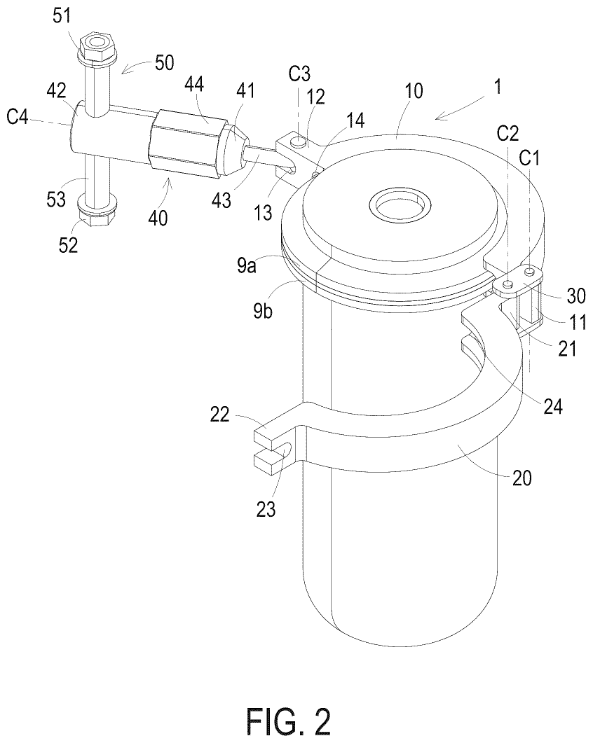

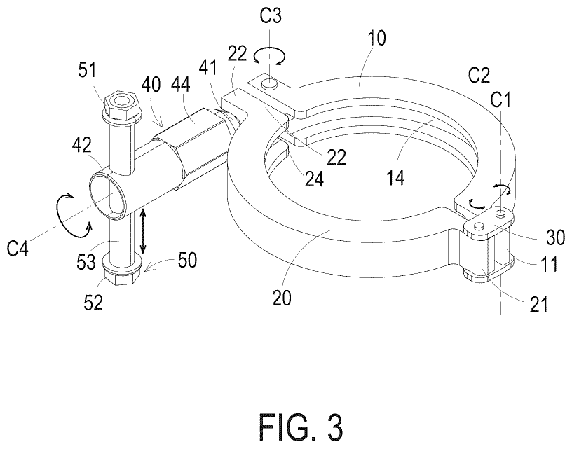

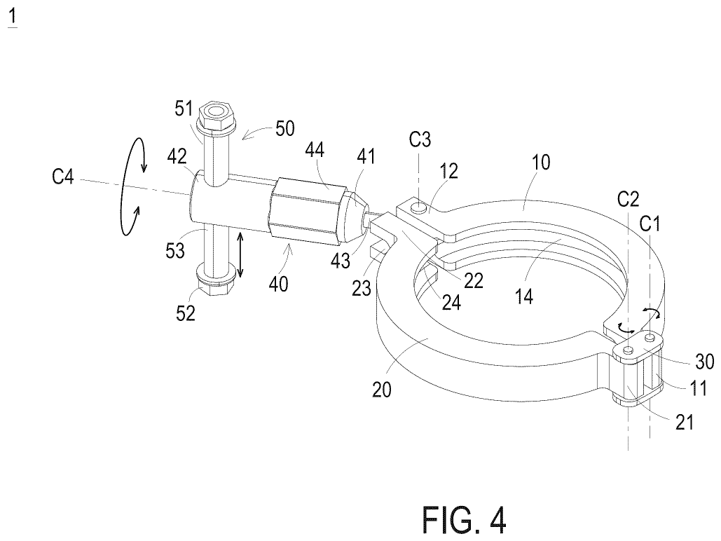

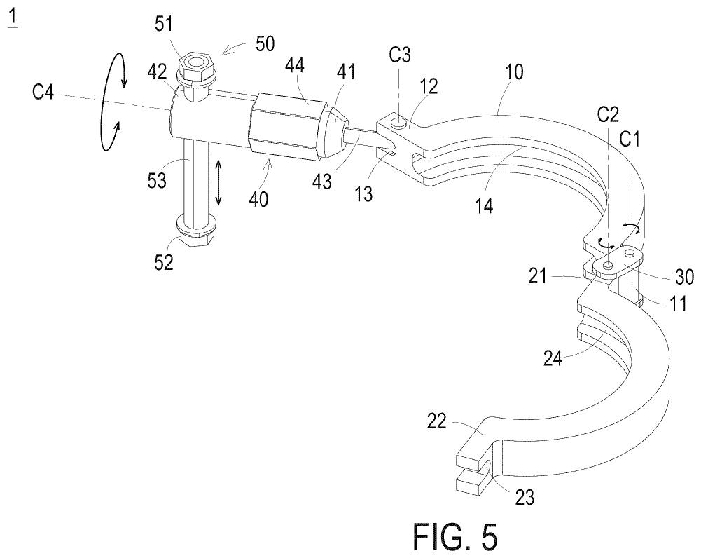

FIG. 1 is a perspective structural view illustrating a sanitary clamp device clamping two sanitary accessories to form a connection according to an embodiment of the present disclosure. FIG. 2 is a perspective structural view illustrating the sanitary clamp device releasing the two sanitary accessories according to the embodiment of the present disclosure. FIG. 3 is a perspective structural view illustrating a locking state of the locking component of the sanitary clamp device according to the embodiment of the present disclosure. FIG. 4 is a perspective structural view illustrating the locking component of the sanitary clamp device releasing the second half-ring component according to the embodiment of the present disclosure. FIG. 5 is a schematic diagram showing the sanitary clamp device fully unfolded according to the embodiment of the present disclosure. Please refer to FIGS. 1 to 5. In the embodiment, the present disclosure provides a sanitary clamp device 1 that releasably connects two sanitary accessories 9a, 9b. Two of the sanitary accessories 9a, 9b, such as the docking components or joints of the water cooling system in the server room, have circular docking surfaces corresponding to each other. The two sanitary accessories 9a, 9b can be clamped and pressed by the sanitary clamp device 1 to tightly connect the two sanitary accessories 9a, 9b. Certainly, the styles and the functions of the sanitary accessories 9a, 9b are not essential features and the present disclosure is not limited thereto. In the embodiment, the sanitary clamp device 1 includes a first half-ring component 10, a second half-ring component 20, a locking component 40 and a cylindrical handle 50. The first half-ring component 10 includes a first pivoted end 11 and a first locked end 12 opposite to each other. The second half-ring component 20 includes a second pivoted end 21 and a second locked end 22 opposite to each other. In the embodiment, the first pivoted end 11 of the first half-ring component 10 and the second pivoted end 21 of the second half-ring component 20 are connected through an adapter component 30, and the first half-ring component 10 and the second half-ring component 20 are allowed rotating relative to each other around the adapter component 30 as a center, respectively, so that the first locked end 12 and the second locked end 22 are matched and engaged with each other to releasably connect two sanitary accessories 9a, 9b between the first half-ring component 10 and the second half-ring component 20 (as shown in FIG. 1), or the first locked end 12 and the second locked end 22 are detached to release the two sanitary accessories 9a, 9b (as shown in FIG. 2).

In the embodiment, the first half-ring component 10 includes a first engaging groove 14 recessed in an inner peripheral wall of the first half-ring component 10. The second half-ring component 20 includes a second engaging groove 24 recessed in an inner peripheral wall of the second half-ring component 20. Moreover, the first engaging groove 14 and the second engaging groove 24 are spatially corresponding to each other. In the embodiment, when the first locked end 12 and the second locked end 22 are locked with each other, the first engaging groove 14 and the second engaging groove 24 are in communication with each other to form an annular groove, so that the two sanitary accessories 9a, 9b are connected between the first half-ring component 10 and the second half-ring component 20 through the annular groove. Certainly, in other embodiments, the first engaging groove 14 of the first half-ring component 10 and the second engaging groove 24 of the second half-ring component 20 can be adjusted according to the joint surface shapes of the two sanitary accessories 9a, 9b. The joint surface shapes are not limited to forming an annular groove. In addition, the way of coupling the two sanitary accessories 9a, 9b tightly is not an essential feature, and the sanitary clamp device 1 of the present disclosure is not limited thereto. In other embodiments, the combination of the first engaging groove 14 of the first half-ring component 10 and the second engaging groove 24 of the second half-ring component 20 is adjustable according to the practical requirements and the present disclosure is not limited thereto.

In the embodiment, the locking component 40 is spatially corresponding to the first locked end 12 and the second locked end 22. Furthermore, the locking component 40 includes a locking end 41 and an operating end 42 opposite to each other. The locking end 41 is connected to the first locked end 12 or the second locked end 22, and the operating end 42 is configured to rotate the locking component 40. In that, the first locked end 12 and the second locked end 22 are pressed and locked by rotating the locking end 41 to approach. Alternatively, the first locked end 12 and the second locked end 22 are released and unlocked by rotating the locking end 41 away. In the embodiment, the cylindrical handle 50 runs through the operating end 42 of the locking component 40. Preferably but not exclusively, the cylindrical handle 50 is allowed sliding vertically relative to the operating end 42 of the locking component 40 to adjust a force-arm length defined from one end of the cylindrical handle 50 to the operating end 42. Thereby, the user can control the rotation of the locking component 40 in a more labor-saving manner, and adjust the force-arm length formed by the cylindrical handle 50 according to the practical requirements.

In the embodiment, the first pivoted end 11 of the first half-ring component 10 is pivoted to the adapter component 30 through a first rotation axis C1, the second pivoted end 21 of the second half-ring component 20 is pivoted to the adapter component 30 through a second rotation axis C2, and the first rotation axis C1 and the second rotation axis C2 are parallel to each other. In other words, the first half-ring component 10 is allowed rotating relative to the adapter component 30 and the second half-ring component 20 with the first rotation axis C1 as a center. The second half-ring component 20 is allowed rotating relative to the adapter component 30 and the first half-ring component 10 with the second rotation axis C2 as a center. Through the pivotal connection of the adapter component 30, the first half-ring component 10 and the second half-ring component 20 are allowed to rotate relative to each other. In the embodiment, when the first locked end 12 of the first half-ring component 10 and the second locked end 22 of the second half-ring component 20 are aligned and close to each other, the two sanitary accessories 9a, 9b are joined through the first half-ring component 10 and the second half-ring component 20. Afterward, the first locked end 12 and the second locked end 22 are further locked through the locking end 41 of the component 40 to realize the connection of the two sanitary accessories 9a, 9b. Preferably but not exclusively, in an embodiment, the first pivoted end 11 of the first half-ring component 10 and the second pivoted end 21 of the second half-ring component 20 are pivoted through one single rotation axis of the adapter component 30. That is, the first rotation axis C1 or the second rotation axis C2 can be omitted, and it still does not affect the close alignment of the first locked end 12 of the first half-ring component 10 and the second locked end 22 of the second half-ring component 20. Preferably but not exclusively, in other embodiments, the first pivoted end 11 of the first half-ring component 10 and the second pivoted end 21 of the second half-ring component 20 are directly pivoted for realizing the engagement or separation of the first locked end 12 of the first half-ring component 10 and the second locked end 22 of the second half-ring component 20. Certainly, the present disclosure is not limited thereto.

In an embodiment, the first locked end 12 includes a first groove 13, the second locked end 22 includes a second groove 23, and the first groove 13 and the second groove 23 are spatially corresponding to each other. Moreover, in the embodiment, the locking component 40 includes a connection column 43. The rear end of the connection column 43 is connected to the locking end 41, and the front end of the connection column 43 is pivoted to the first locked end 12 from the first groove 13 through a third rotation axis C3. The third rotation axis C3 is parallel to the first rotation axis C1 and the second rotation axis C2. Moreover, the connection column 43 is spatially corresponding to the first groove 13 and the second groove 23. Preferably but not exclusively, when the first locked end 12 of the first half-ring component 10 and the second locked end 22 of the second half-ring component 20 are aligned and close to each other, the locking component 40 is allowed rotating around the third rotation axis C3 as a center through the connection column 43, so that the connection column 43 is received in the second groove 23. At this time, the locking end 41 of the locking component 40 is further rotated to approach the second locked end 22 to lock the first locked end 12 and the second locked end 22, thereby realizing the joint connection of the two sanitary accessories 9a, 9b. Certainly, if the locking end 41 of the locking component 40 does not abut the second locked end 22, the locking component 40 is still allowed rotating around the third rotation axis C3 through the connection column 43, so as to be moved away from the second groove 23. At this time, the second locked end 22 of the second half-ring component 20 can be rotated away from the first locked end 12 of the first half-ring component 10 around the second rotation axis C2 to allow the release of the two sanitary accessories 9a, 9b.

In the embodiment, the connection column 43, the locking end 41 and the operating end 42 are arranged along a fourth rotation axis C4, and the fourth rotation axis C4 is perpendicular to the third rotation axis C3. The locking end 41 and the operating end 42 are allowed rotating around the fourth rotation axis C4 to adjust the distance from the locking end 41 to the third rotation axis C3. In an embodiment, when the connection column 43 is received in the second groove 23, the operating end 42 is allowed rotating the locking component 40 to abut the second locked end 22 through the locking end 41, so that the first locked end 12 and the second locked end 22 are engaged and locked. That is, the joint connection of the two sanitary accessories 9a, 9b is achieved.

Notably, in the embodiment, the cylindrical handle 50 intersects perpendicularly with the fourth rotation axis C4. In the embodiment, the cylindrical handle 50 includes two limiting parts 51, 52, and the two limiting parts 51, 52 are detachably connected to two opposite ends of the cylindrical handle 50. In the embodiment, the cylindrical handle 50 forms a sliding section 53 between the two limiting parts 51, 52. Preferably but not exclusively, the sliding section 53 is a cylinder, so as to facilitate the cylindrical handle 50 to slide relative to the operating end 42. In the embodiment, when one of the two limiting parts 51, 52 is in contact with the operating end 42 of the locking component 40, the other of the two limiting parts 51, 52 forms a maximum force-arm length relative to the operating end 42. Preferably but not exclusively, when the limiting part 51 of the cylindrical handle 50 is in contact with the operating end 42 of the locking component 40, the limiting part 52 forms a maximum force-arm length relative the operating end 42. Notably, since the operating end 42 of the locking component 40 is allowed to rotate around the fourth rotation axis C4, the cylindrical handle 50 vertically running through the operating end 42 is rotated along with the rotation of the operating end 42. No matter the operating end 42 of the locking component 40 is rotated to any angle, the cylindrical handle 50 is allowed to slide vertically relative to the operating end 42. On the other hand, during the rotation of the operating end 42 of the locking component 40, the two limiting parts 51,52 of the cylindrical handle 50 can be slid, adjusted or exchanged arbitrarily and served as the force application point. In the present disclosure, the rotational locking operation or the rotational releasing operation of the locking component 40 is not limited to being performed through a fixed force arm. In other words, when the cylindrical handle 50 rotates the locking component 40 to lock or release, the force-arm length of the cylindrical handle 50 can be adjusted arbitrarily, and the cylindrical handle 50 can be easily adjusted to a suitable position at any angle for locking and unlocking. Thereby, the space waste is reduced, and the obstacles of environmental space are overcome. Moreover, the installation or the disassembly of the sanitary clamp device 1 can be successfully completed.

Preferably but not exclusively, in an embodiment, the cylindrical handle 50 includes a double-headed bolt, and the two limiting parts 51, 52 are two nuts, which are detachably connected to two opposite ends of the double-headed bolt. In that, the cylindrical handle 50 is detachably disposed at the operating end 42 of the locking component 40. It facilitates the replacement of the cylindrical handle 50 to achieve different ranges of force-arm operations. Certainly, the present disclosure is not limited thereto.

In the embodiment, the locking component 40 further includes an auxiliary operating section 44. The auxiliary operating section 44 is connected between the locking end 41 and the operating end 42, and configured for a tool to hold to operate the locking component 40. Preferably but not exclusively, the auxiliary operating section 44 is a hexagonal cylinder or a hexagonal nut. Thereby, in the operating space constructed by the cylindrical handle 50 and the locking component 40, the auxiliary operating section 44, such as a hexagonal nut, is added for other auxiliary tools to hold and operate the locking component 40. During production quality control, the sanitary clamp device 1 further provides a reserved auxiliary operating section 44 for the factory torque wrench to perform the torque control. Certainly, the present disclosure is not limited thereto.

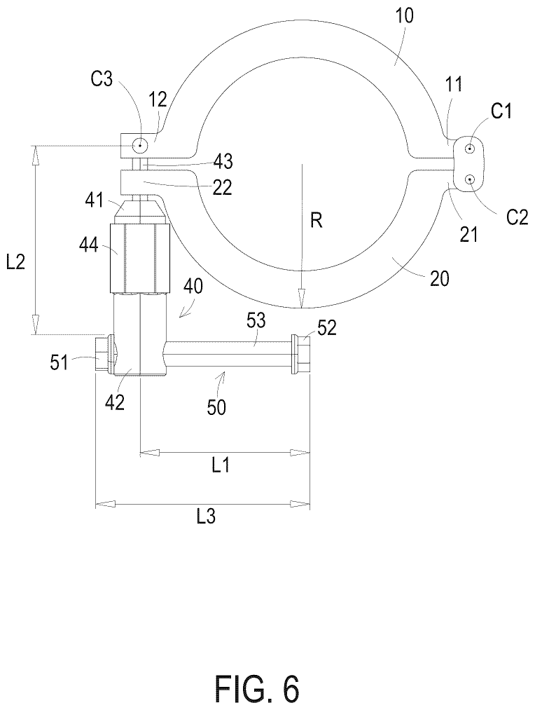

FIG. 6 is a schematic diagram showing the dimensional relationship of each component in the sanitary clamp device according to the embodiment of the present disclosure. Please refer to FIG. 1 to FIG. 6. In the embodiment, the sizes and the shapes of the first half-ring component 10 and the second half-ring component 20 can be designed according to the sanitary accessories that need to be joined. The joint connection of the two sanitary accessories 9a, 9b with any shape and size can be achieved through the sanitary clamp device 1 with bare hands. The sanitary clamp device 1 of the present disclosure is allowed adjusting the combined size of the first half-ring component 10 and the second half-ring component 20, and then combining the locking component 40 and the cylindrical handle 50. Compared with the space restrictions caused by the first half-ring component 10 and the second half-ring component 20 when clamping the sanitary accessories 9a, 9b, the cylindrical handle 50 and the locking component 40 are installed and operated in a more space-saving space. In the embodiment, when the limiting part 51 of the cylindrical handle 50 is slid relative to the operating end 42 and in contact with the operating end 42 of the locking component 40, the other limiting part 52 further forms a maximum force-arm length L1 relative to the operating end 42, as shown in FIG. 6. In addition, when the locking component 40 is rotated around the fourth rotation axis C4 and operated through the cylindrical handle 50, the cylindrical handle 50 forms an operating distance L2 relative to the third rotation axis C3. Moreover, the first half-ring component 10 and the second half-ring component 20 have a peripheral radius R. Preferably but not exclusively, in the embodiment, the operating distance L2 is greater than the peripheral radius R and less than twice the peripheral radius R. In that, when the cylindrical handle 50 performs the rotation of the locking component 40 with the maximum force-arm length L1, the collision between the cylindrical handle 50 and the second half-ring component 20 is avoided, and the operating space does not exceed the space restriction of the first half-ring component 10 and the second half-ring component 20 clamping the sanitary accessories 9a, 9b. In addition, the locking component 40 has the auxiliary operating section 44 disposed between the locking end 41 and the operating end 42 with the cylindrical handle 50 running through, so as to make good use of space. Preferably but not exclusively, in the embodiment, the two limiting parts 51, 52 of the cylindrical handle 50 form a handle length L3, and the preferred range of the handle length is no more than twice the peripheral radius R. Certainly, the size and type of the locking component 40 and the cylindrical handle 50 are adjustable according to the practical requirements. The present disclosure is not limited thereto and not redundantly described hereafter.

In summary, the present disclosure provides a sanitary clamp device used to releasably connect two sanitary accessories of the water cooling system, and capable of being removed or installed without tools when replacing the clamped sanitary accessories, so as to effectively simplify the operating procedures and improve the work efficiency. The two pivoted half-ring components are locked together by a locking component with a cylindrical handle, so that the two sanitary accessories can be releasably connected between the two half-ring components. Since the cylindrical handle is slidingly connected to the locking component, when the user wants to connect two sanitary accessories between the two half-ring components, the installation or disassembly of the sanitary clamp device can be completed by operating the locking component through the cylindrical handle. There is no need to carry other tools such as movable wrenches, spanners, and screwdrivers. The sanitary clamp device or the present disclosure is operated with bare hands. The locking component needs to provide high locking torque to lock the locked ends of the two half-ring components. By sliding the cylindrical handle vertically relative to the locking component, a force-arm length defined from one end of the cylindrical handle to the rotation axis of the locking component is adjustable. It allows the users to easily install or remove the sanitary clamp device. The user can adjust the length of the cylindrical handle relative to the rotation axis of the locking component to increase the locking torque. Furthermore, when the cylindrical handle rotates the locking component to lock or release, the length of the cylindrical handle can be adjusted arbitrarily, and the cylindrical handle can be easily adjusted to a suitable position at any angle for disassembly and assembly. Thereby, the space waste is reduced, and the obstacles of environmental space are overcome. Moreover, the installation or the disassembly of the sanitary clamp device can be successfully completed. On the other hand, the cylindrical handle and locking component have smaller size and operating space than the two half-ring components. Preferably, the size of the two half-ring components is designed relative to the two connected sanitary accessories. The sanitary clamp device can be constructed for any shape and size easily, and the operation is completed with bare hands, so that the use of other tools is eliminated. In the operating space constructed by the cylindrical handle and the locking component, an auxiliary operating section such as a hexagonal nut can also be added for other auxiliary tools to hold and control the locking component. In this way, during production quality control, the sanitary clamp device of the present disclosure further provides the auxiliary operating section for the factory torque wrench to perform the torque control. The sanitary clamp device can be used to connect the accessories of the water cooling system. When replacing the clamped sanitary accessories, tool-free removal or installation is achieved.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A sanitary clamp device, comprising:
a first half-ring component comprising a first pivoted end and a first locked end opposite to each other;
a second half-ring component comprising a second pivoted end and a second locked end opposite to each other, wherein the first pivoted end of the first half-ring component and the second pivoted end of the second half-ring component are connected through an adapter component, and the first half-ring component and the second half-ring component are allowed rotating relative to each other around the adapter component as a center, respectively, so that the first locked end and the second locked end are engaged with each other to releasably connect two sanitary accessories between the first half-ring component and the second half-ring component, or the first locked end and the second locked end are detached to release the two sanitary accessories;
a locking component spatially corresponding to the first locked end and the second locked end, wherein the locking component comprises a locking end and an operating end opposite to each other, the locking end is connected to the first locked end or the second locked end, and the operating end is configured to rotate the locking end, so that the first locked end and the second locked end are locked or unlocked through the locking end; and
a cylindrical handle running through the operating end of the locking component, wherein the cylindrical handle is allowed sliding relative to the operating end to adjust a force-arm length defined from one end of the cylindrical handle to the operating end.

2. The sanitary clamp device according to claim 1, wherein the first pivoted end of the first half-ring component is pivoted to the adapter component through a first rotation axis, the second pivoted end of the second half-ring component is pivoted to the adapter component through a second rotation axis, and the first rotation axis and the second rotation axis are parallel to each other.

3. The sanitary clamp device according to claim 2, wherein the first locked end comprises a first groove, the second locked end comprises a second groove, and the first groove and the second groove are spatially corresponding to each other, wherein the locking component comprises a connection column, one end of the connection column is connected to the locking end, the other end of the connection column is pivoted to the first locked end from the first groove through a third rotation axis, the third rotation axis is parallel to the first rotation axis and the second rotation axis, and the connection column is spatially corresponding to the first groove and the second groove, wherein the locking component is allowed rotating around the third rotation axis as a center through the connection column, so that the connection column is received in the second groove or moved away from the second groove.

4. The sanitary clamp device according to claim 3, wherein the connection column, the locking end and the operating end are arranged along a fourth rotation axis, the fourth rotation axis is perpendicular to the third rotation axis, and when the connection column is received in the second groove, the operating end is allowed rotating the locking component to abut the second locked end through the locking end, so that the first locked end and the second locked end are engaged and locked.

5. The sanitary clamp device according to claim 4, wherein the cylindrical handle intersects perpendicularly with the fourth rotation axis.

6. The sanitary clamp device according to claim 4, wherein the cylindrical handle forms an operating distance relative to the third rotation axis, the first half-ring component and the second half-ring component have a peripheral radius, and the operating distance is greater than the peripheral radius and less than twice the peripheral radius.

7. The sanitary clamp device according to claim 1, wherein the cylindrical handle comprises two limiting parts, and the two limiting parts are detachably connected to two opposite ends of the cylindrical handle.

8. The sanitary clamp device according to claim 7, wherein the cylindrical handle comprises a double-headed bolt, and the two limiting parts are two nuts, which are detachably connected to two opposite ends of the double-headed bolt.

9. The sanitary clamp device according to claim 7, wherein the cylindrical handle forms a sliding section between the two limiting parts, and the sliding section is a cylinder.

10. The sanitary clamp device according to claim 7, wherein when one of the two limiting parts is in contact with the operating end of the locking component, the other of the two limiting parts forms a maximum force-arm length relative to the operating end.

11. The sanitary clamp device according to claim 1, wherein the locking component further comprises an auxiliary operating section, the auxiliary operating section is connected between the locking end and the operating end and configured for a tool to hold to operate the locking component.

12. The sanitary clamp device according to claim 11, wherein the auxiliary operating section is a hexagonal cylinder or a hexagonal nut.

13. The sanitary clamp device according to claim 1, wherein the first half-ring component comprises a first engaging groove recessed in an inner peripheral wall of the first half-ring component, the second half-ring component comprises a second engaging groove recessed in an inner peripheral wall of the second half-ring component, and the first engaging groove and the second engaging groove are spatially corresponding to each other, wherein when the first locked end and the second locked end are locked with each other, the first engaging groove and the second engaging groove are in communication with each other to form an annular groove, so that the two sanitary accessories are connected between the first half-ring component and the second half-ring component.
